(19) United States
(12) Patent Application Publication
(10) Pub. No.: US 2026/0161036 A1
(43) Pub. Date: Jun. 11, 2026

(54) DISPLAY DEVICE

(71) Applicant: Japan Display Inc., Tokyo (JP)

(72) Inventors: Yoshihide OHUE, Tokyo (JP); Yukiya HIRABAYASHI, Tokyo (JP); Takahiro SHOJI, Tokyo (JP); Kosuke TAKASU, Tokyo (JP); Kentaro OKUYAMA, Tokyo (JP)

(73) Assignee: Japan Display Inc., Tokyo (JP)

(21) Appl. No.: 19/413,270

(22) Filed: Dec. 9, 2025

(30) Foreign Application Priority Data
Dec. 10, 2024 (JP) 2024-215882

(51) Int. Cl. G02F 1/1368; G02F 1/13357; G02F 1/1343; G02F 1/1362

(52) U.S. Cl. CPC G02F 1/1368; G02F 1/1336; G02F 1/134309; G02F 1/136286

(57) ABSTRACT

According to an aspect, a display device includes an array substrate, a counter substrate, a liquid crystal layer between the array substrate and the counter substrate, and a light source. The array substrate includes, signal lines, scan lines, and switching elements. Each switching element includes a semiconductor layer that has a first side surface located on a side closer to the light source and a second side surface on an opposite side to the first side surface. The semiconductor layer has a first width and a second width, the first width being a width in a direction intersecting an incident direction in which light is incident from the light source, the second width being a width in a direction parallel to the incident direction, the first width being smaller than the second width. A source electrode coupled to the signal line covers the first side surface of the semiconductor layer.

### CROSS-REFERENCE TO RELATED APPLICATION

This application claims the benefit of priority from Japanese Patent Application No. 2024-215882 filed on Dec. 10, 2024, the entire contents of which are incorporated herein by reference.

### BACKGROUND

### 1. Technical Field

What is disclosed herein relates to a display device.

### 2. Description of the Related Art

WO 2022/153665 and WO 2022/153664 describe a display device that includes a first light-transmitting substrate, a second light-transmitting substrate located so as to face the first light-transmitting substrate, a liquid crystal layer including a polymer-dispersed liquid crystal enclosed between the first and the second light-transmitting substrates, and a plurality of light-emitting elements (light-emitting module) located so as to face at least one of side surfaces of the first and the second light-transmitting substrates. In the display device described in WO 2022/153665 and WO 2022/153664, a viewer on one surface side of a display panel can view a background on the other surface side opposite to the one surface side.

In such a display device, a light source (described as the light emitting module in WO 2022/153665 and WO 2022/153664) is located so as to face at least one of the side surfaces of the first and the second light-transmitting substrates. Therefore, light leakage of a switching element by the light source needs to be reduced.

### SUMMARY

According to an aspect, a display device includes: an array substrate; a counter substrate having a first end; a liquid crystal layer between the array substrate and the counter substrate; and a light source located on an opposite side to the liquid crystal layer on the first end. The array substrate includes: a plurality of signal lines arranged in a first direction; a plurality of scan lines arranged in a second direction intersecting the first direction; and a plurality of switching elements coupled to the scan lines and the signal lines. Each of the switching elements includes a semiconductor layer that has a first side surface located on a side closer to the light source and a second side surface on an opposite side to the first side surface. The semiconductor layer has a first width and a second width, the first width being a width in a direction intersecting an incident direction in which light is incident from the light source, the second width being a width in a direction parallel to the incident direction, the first width being smaller than the second width. A source electrode coupled to the signal line covers the first side surface of the semiconductor layer.

### BRIEF DESCRIPTION OF THE DRAWINGS

FIG. 1 is a perspective view illustrating an example of a display panel according to an embodiment of the present disclosure;

FIG. 2 is a block diagram illustrating a display device according to a first embodiment of the present disclosure;

FIG. 3 is a timing diagram explaining timing of light emission by a light source in a field-sequential system of the first embodiment;

FIG. 4 is an explanatory diagram illustrating a relation between a voltage applied to a pixel electrode and a scattering state of a pixel;

FIG. 5 is a sectional view illustrating an example of a section of the display device;

FIG. 6 is a plan view illustrating a planar surface of the display device of FIG. 1;

FIG. 7 is an enlarged sectional view obtained by enlarging a liquid crystal layer portion of FIG. 5;

FIG. 8 is a sectional view for explaining a non-scattering state in the liquid crystal layer;

FIG. 9 is a sectional view for explaining the scattering state in the liquid crystal layer;

FIG. 10 is a plan view illustrating scan lines, signal lines, and a switching element in the pixel;

FIG. 11 is a plan view illustrating a holding capacitance layer in the pixel;

FIG. 12 is a plan view illustrating the switching element in the pixel;

FIG. 13 is a plan view illustrating a pixel electrode in the pixel;

FIG. 14 is a plan view illustrating a light-blocking layer in the pixel;

FIG. 15 is a sectional view taken along section XV-XV′ in FIG. 12;

FIG. 16 is a sectional view taken along section XVI-XVI′ in FIG. 14;

FIG. 17 is a sectional view taken along section XVII-XVII′ in FIG. 14;

FIG. 18 is a sectional view illustrating the switching element according to a first modification of the present disclosure;

FIG. 19 is a plan view illustrating the switching element of a display device according to a second embodiment of the present disclosure;

FIG. 20 is a sectional view taken along section XX-XX′ in FIG. 19;

FIG. 21 is a plan view illustrating the switching element according to a second modification of the present disclosure;

FIG. 22 is a sectional view taken along section XXII-XXII′ in FIG. 21; and

FIG. 23 is a plan view illustrating the switching element according to a third modification of the present disclosure.

### DETAILED DESCRIPTION

The following describes modes (embodiments) for carrying out the present disclosure in detail with reference to the drawings. The present disclosure is not limited to the description of the embodiments given below. Components described below include those easily conceivable by those skilled in the art or those substantially identical thereto. In addition, the components described below can be combined as appropriate. What is disclosed herein is merely an example, and the present disclosure naturally encompasses appropriate modifications easily conceivable by those skilled in the art while maintaining the gist of the disclosure. To further clarify the description, the drawings may schematically illustrate, for example, widths, thicknesses, and shapes of various parts as compared with actual aspects thereof. However, they are merely examples, and interpretation of the present disclosure is not limited thereto. The same element as that illustrated in a drawing that has already been discussed is denoted by the same reference numeral through the present disclosure and the drawings, and detailed description thereof may not be repeated where appropriate.

In the present disclosure, in expressing an aspect of disposing a first structure above or on a second structure, a case of simply expressing “on” includes both a case of disposing the first structure immediately on the second structure so as to contact the second structure and a case of disposing the first structure above the second structure with still another structure interposed therebetween, unless otherwise specified.

### First Embodiment

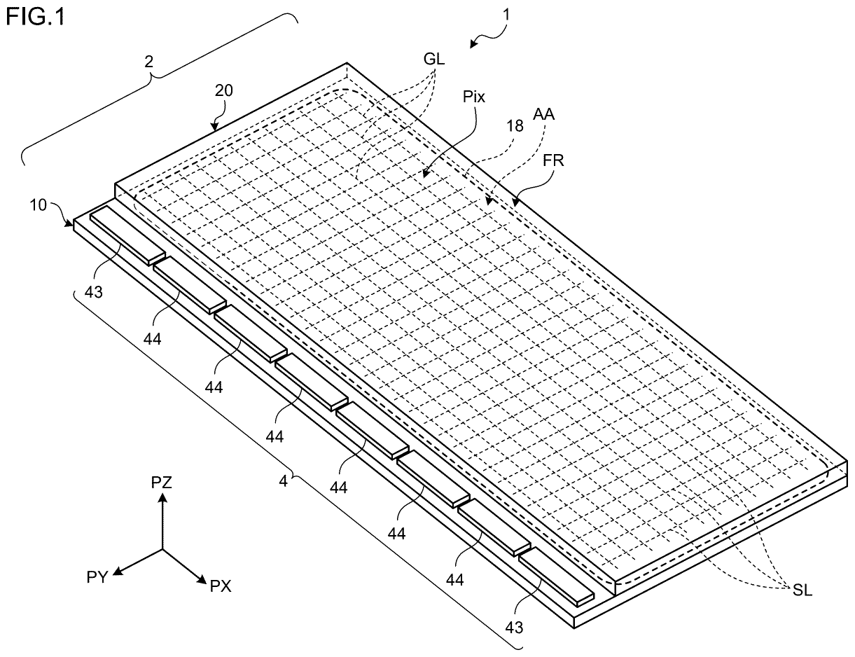

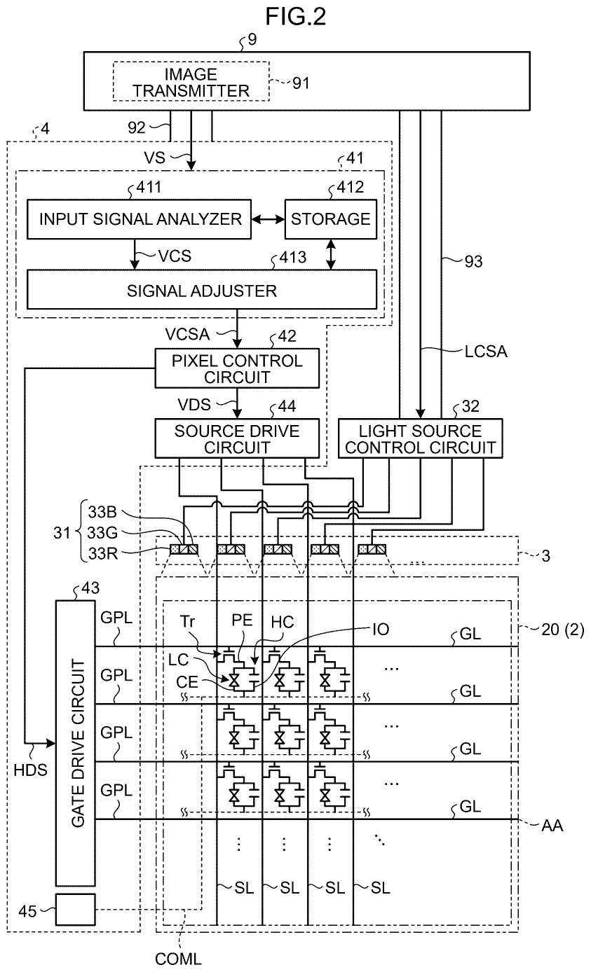

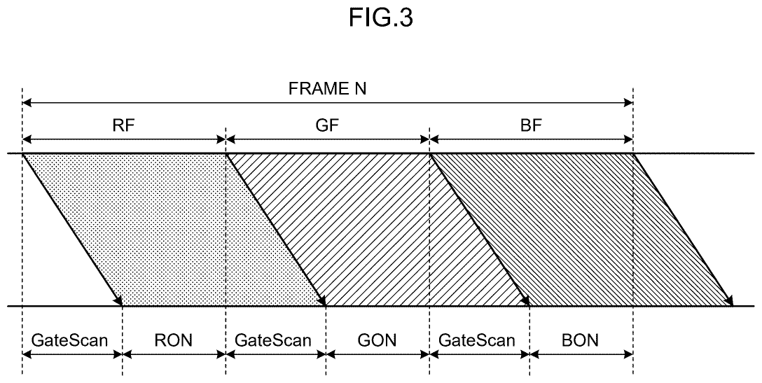

FIG. 1 is a perspective view illustrating an example of a display panel according to an embodiment of the present disclosure. FIG. 2 is a block diagram illustrating a display device according to a first embodiment of the present disclosure. FIG. 3 is a timing diagram explaining timing of light emission by a light source in a field-sequential system of the first embodiment.

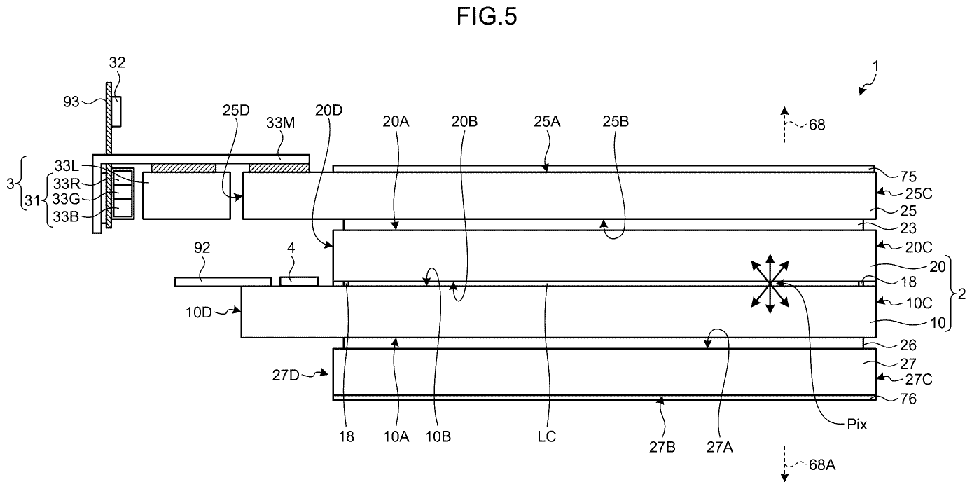

As illustrated in FIG. 1, a display device 1 includes a display panel 2, a light source 3 (refer to FIG. 5), and a drive circuit 4. An array substrate 10 has a larger area than that of a counter substrate 20 in a PX-PY plane, and the drive circuit 4 is provided on a projecting portion of the array substrate 10 exposed from the counter substrate 20. The drive circuit 4 includes at least a gate drive circuit 43 and a source drive circuit 44, which are described below. A first direction PX denotes one direction in the plane of the display panel 2. A second direction PY denotes a direction orthogonal to the first direction PX. A third direction PZ denotes a direction orthogonal to the PX-PY plane. The term “plan view” refers to a positional relation as viewed along the third direction PZ.

The display panel 2 includes the array substrate 10, the counter substrate 20, and a liquid crystal layer 50 (refer to FIG. 5). The array substrate 10 serves as a first light-transmitting substrate, and the counter substrate 20 serves as a second light-transmitting substrate. The counter substrate 20 faces a surface of the array substrate 10 in a direction orthogonal thereto (in the third direction PZ illustrated in FIG. 1). In the liquid crystal layer 50 (refer to FIG. 5), a polymer-dispersed liquid crystal LC (to be described later) is sealed by the array substrate 10, the counter substrate 20, and a seal 18.

As illustrated in FIG. 1, the display panel 2 has an active area AA capable of displaying images and a peripheral area FR outside the active area AA. A plurality of pixels Pix are arranged in a matrix having a row-column configuration in the active area AA. In the present disclosure, a row refers to a pixel row including m pixels Pix arranged in one direction. A column refers to a pixel column including n pixels Pix arranged in a direction orthogonal to the direction in which the rows are arranged. The values of m and n are determined according to a display resolution in the vertical direction and a display resolution in the horizontal direction. A plurality of scan lines GL are provided corresponding to the rows, and a plurality of signal lines SL are provided corresponding to the columns.

As illustrated in FIG. 2, the light source 3 includes a plurality of light emitters 31. A light source controller (light source control circuit) 32 is provided on a wiring board 93 The wiring board 93 is a flexible printed circuit board or a printed circuit board (PCB). A light source control signal LCSA is transmitted from an image transmitter 91 of an external higher-level controller 9 to the light source controller 32. The light source control signal LCSA is a signal including information on light quantities of the light emitters 31 set based on, for example, input gradation values to be given to the pixels Pix.

As illustrated in FIG. 1, the drive circuit 4 is fixed to the surface of the array substrate 10. As illustrated in FIG. 2, the drive circuit 4 includes a signal processing circuit 41, a pixel control circuit 42, a gate drive circuit 43, a source drive circuit 44, and a common potential drive circuit 45.

The signal processing circuit 41 receives a first input signal (such as a red-green-blue (RGB) signal) VS from the image transmitter 91 of the external higher-level controller 9 via a flexible printed circuit board 92.

The signal processing circuit 41 includes an input signal analyzer 411, a storage 412, and a signal adjuster 413. The input signal analyzer 411 generates a second input signal VCS based on the externally received first input signal VS.

The second input signal VCS is a signal for determining a gradation value to be given to each of the pixels Pix of the display panel 2 based on the first input signal VS. In other words, the second input signal VCS is a signal including gradation information on the gradation value of each of the pixels Pix.

The signal adjuster 413 generates a third input signal VCSA from the second input signal VCS. The signal adjuster 413 transmits the third input signal VCSA to the pixel control circuit 42.

The pixel control circuit 42 generates a horizontal drive signal HDS and a vertical drive signal VDS based on the third input signal VCSA. In the present embodiment, since the display device 1 is driven based on the field-sequential system, the horizontal drive signal HDS and the vertical drive signal VDS are generated for each color emittable by the light emitters 31.

The gate drive circuit 43 sequentially selects the scan lines GL of the display panel 2 based on the horizontal drive signal HDS within one vertical scan period. The scan lines GL can be selected in any order. The gate drive circuit 43 is electrically coupled to the scan lines GL via second wiring GPL arranged in the peripheral area FR outside the active area AA (refer to FIG. 1).

The source drive circuit 44 supplies gradation signals corresponding to output gradation values of the pixels Pix to the signal lines SL of the display panel 2 based on the vertical drive signal VDS within one horizontal scan period.

In the present embodiment, the display panel 2 is an active matrix panel. Therefore, the display panel 2 includes the signal (source) lines SL extending in the second direction PY and the scan (gate) lines GL extending in the first direction PX in plan view, and includes switching elements Tr at intersections between the signal lines SL and the scan lines GL.

A thin-film transistor is used as each of the switching elements Tr. A bottom-gate transistor or a top-gate transistor may be used as an example of the thin-film transistor. Although a single-gate thin film transistor is exemplified as the switching element Tr, the switching element Tr may be a double-gate transistor. One of a source electrode and a drain electrode of the switching element Tr is coupled to a corresponding one of the signal lines SL. A gate electrode of the switching element Tr is coupled to a corresponding one of the scan lines GL. The other of the source electrode and the drain electrode is coupled to a capacitance of the polymer-dispersed liquid crystal LC to be described later at one end side. The capacitance of the polymer-dispersed liquid crystal LC is coupled at the one end side thereof to the switching element Tr via a pixel electrode PE, and coupled at the other end side thereof to common potential wiring COML via a common electrode CE. Holding capacitance HC is generated between the pixel electrode PE and a holding capacitance electrode IO electrically coupled to the common potential wiring COML. The common potential wiring COML is supplied with a potential from the common potential drive circuit 45.

Each of the light emitters 31 includes a light emitter 33R of a first color (such as red), a light emitter 33G of a second color (such as green), and a light emitter 33B of a third color (such as blue). The light source controller 32 controls the light emitter 33R of the first color, the light emitter 33G of the second color, and the light emitter 33B of the third color so as to emit light in a time-division manner based on the light source control signal LCSA. In this way, the light emitter 33R of the first color, the light emitter 33G of the second color, and the light emitter 33B of the third color are driven based on the field-sequential system.

As illustrated in FIG. 3, in a first sub-frame (first predetermined time) RF, the light emitter 33R of the first color emits light during a first color light emission period RON, and the pixels Pix selected during one vertical scan period GateScan scatter light to perform display. On the entire display panel 2, if the gradation signal corresponding to the output gradation value of each of the pixels Pix is supplied to the above-described signal lines SL for the pixels Pix selected during the one vertical scan period GateScan, only the first color is lit up during the first color light emission period RON.

Then, in a second sub-frame (second predetermined time) GF, the light emitter 33G of the second color emits light during a second color light emission period GON, and the pixels Pix selected during the one vertical scan period GateScan scatter light to perform display. On the entire display panel 2, if the gradation signal corresponding to the output gradation value of each of the pixels Pix is supplied to the above-described signal lines SL for the pixels Pix selected during the one vertical scan period GateScan, only the second color is lit up during the second color light emission period GON.

Further, in a third sub-frame (third predetermined time) BF, the light emitter 33B of the third color emits light during a third color light emission period BON, and the pixels Pix selected during the one vertical scan period GateScan scatter light to perform display. On the entire display panel 2, if the gradation signal corresponding to the output gradation value of each of the pixels Pix is supplied to the above-described signal lines SL for the pixels Pix selected during the one vertical scan period GateScan, only the third color is lit up during the third color light emission period BON.

Since a human eye has a limited temporal resolution and produces an afterimage, an image with a combination of three colors is recognized in a period of one frame (1F). The field-sequential system can eliminate the need for a color filter, and thus can reduce an absorption loss by the color filter. As a result, higher transmittance can be obtained. In a color filter system, one pixel is made up of sub-pixels obtained by dividing each of the pixels Pix into the sub-pixels of the first color, the second color, and the third color. In contrast, in the field-sequential system, the pixel need not be divided into the sub-pixels in such a manner. A fourth sub-frame may be further included to emit light in a fourth color different from any one of the first color, the second color, and the third color.

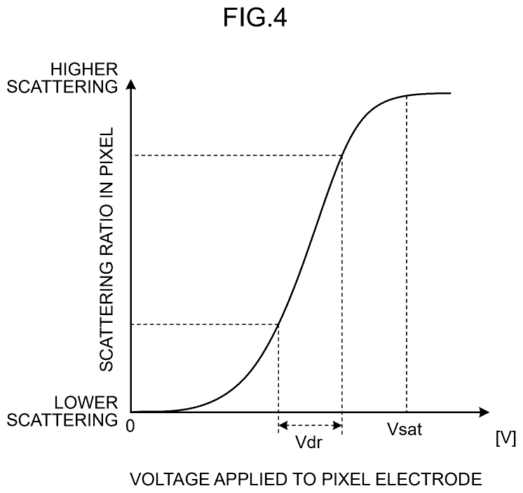

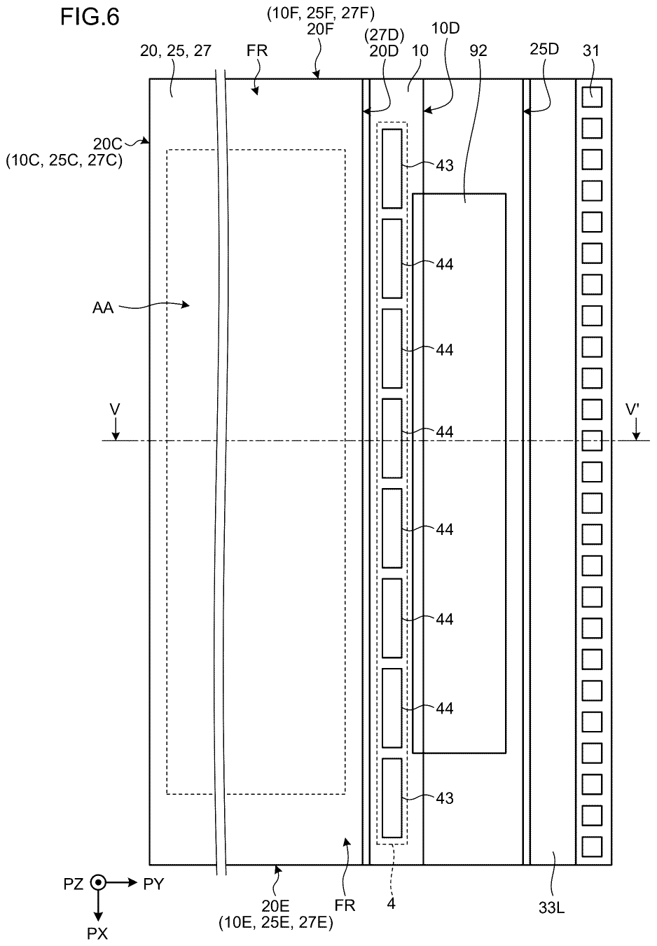

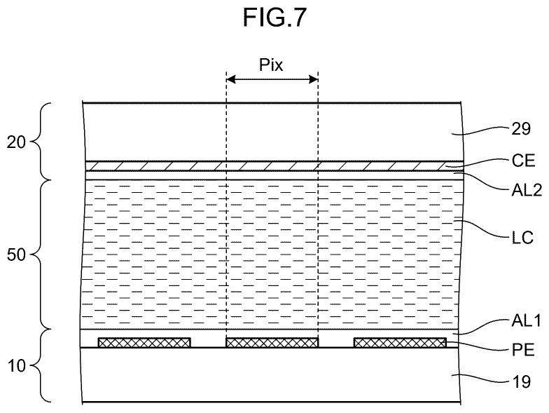

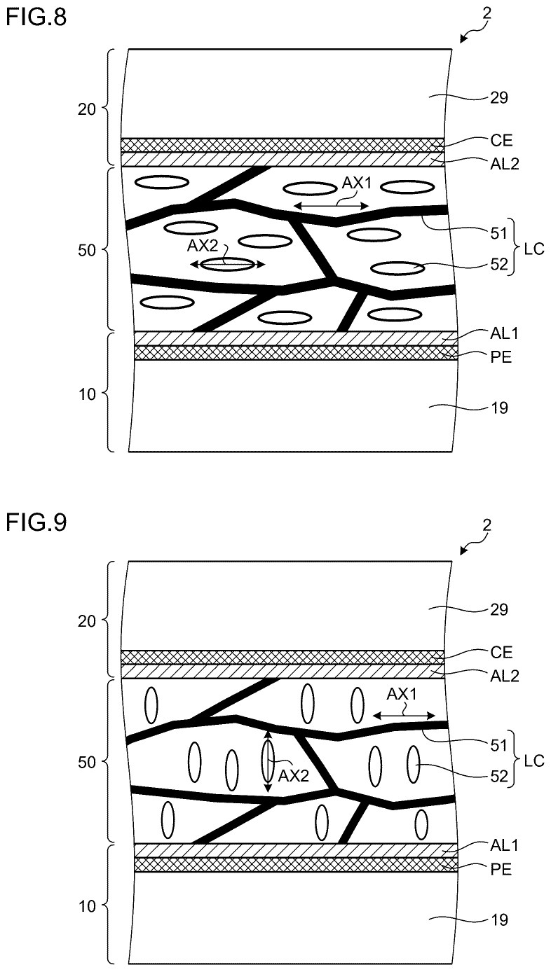

FIG. 4 is an explanatory diagram illustrating a relation between a voltage applied to the pixel electrode and a scattering state of the pixel. FIG. 5 is the sectional view illustrating an example of a section of the display device. FIG. 6 is a plan view illustrating a planar surface of the display device of FIG. 1. FIG. 7 is an enlarged sectional view obtained by enlarging the liquid crystal layer portion of FIG. 5. FIG. 8 is a sectional view for explaining a non-scattering state in the liquid crystal layer. FIG. 9 is a sectional view for explaining the scattering state in the liquid crystal layer.

If the gradation signal corresponding to the output gradation value of each of the pixels Pix is supplied to the above-described signal lines SL for the pixels Pix selected during the one vertical scan period GateScan, the voltage applied to the pixel electrode PE changes with the gradation signal. The change in the voltage applied to the pixel electrode PE changes the voltage between the pixel electrode PE and the common electrode CE. The scattering state of the liquid crystal layer 50 for each of the pixels Pix is controlled according to the voltage applied to the pixel electrode PE, and the scattering ratio in the pixels Pix changes, as illustrated in FIG. 4.

As illustrated in FIG. 4, the change in the scattering ratio in the pixel Pix is smaller when the voltage applied to the pixel electrode PE is equal to or higher than a saturation voltage Vsat. Therefore, the drive circuit 4 changes the voltage applied to the pixel electrode PE according to the vertical drive signal VDS within a voltage range Vdr lower than the saturation voltage Vsat.

As illustrated in FIG. 5, the display device 1 includes a light-transmitting first base member 25, the display panel 2, and a light-transmitting second base member 27. A protective layer 75 is provided on one surface of the light-transmitting first base member 25. A protective layer 76 is provided on one surface of the light-transmitting second base member 27.

The display panel 2 includes the array substrate 10, the counter substrate 20, and the liquid crystal layer 50. The counter substrate 20 faces a surface of the array substrate 10 in a direction orthogonal to the array substrate 10 (in the third direction PZ illustrated in FIG. 1). In the liquid crystal layer 50, the polymer-dispersed liquid crystal (to be described later) is sealed by the array substrate 10, the counter substrate 20, and the seal 18.

As illustrated in FIGS. 5 and 6, the array substrate 10 has a first principal surface 10A, a second principal surface 10B, a first side surface 10C, a second side surface 10D, a third side surface 10E, and a fourth side surface 10F. The first principal surface 10A and the second principal surface 10B are flat surfaces parallel to each other. The first side surface 10C and the second side surface 10D are flat surfaces parallel to each other. The third side surface 10E and the fourth side surface 10F are flat surfaces parallel to each other.

As illustrated in FIGS. 5 and 6, the counter substrate 20 has a first principal surface 20A, a second principal surface 20B, a first side surface 20C, a second side surface 20D, a third side surface 20E, and a fourth side surface 20F. The first principal surface 20A and the second principal surface 20B are flat surfaces parallel to each other. The first side surface 20C and the second side surface 20D are flat surfaces parallel to each other. The third side surface 20E and the fourth side surface 20F are flat surfaces parallel to each other.

As illustrated in FIGS. 5 and 6, the first base member 25 has a first principal surface 25A, a second principal surface 25B, a first side surface 25C, a second side surface 25D, a third side surface 25E, and a fourth side surface 25F. The first principal surface 25A and the second principal surface 25B are flat surfaces parallel to each other. The first side surface 25C and the second side surface 25D are flat surfaces parallel to each other. The third side surface 25E and the fourth side surface 25F are flat surfaces parallel to each other.

The first base member 25 is bonded to the first principal surface 20A of the counter substrate 20 with an optical resin 23 interposed therebetween. The first base member 25 is a protective substrate for the counter substrate 20, and is formed, for example, of glass or a light-transmitting resin. When the first base member 25 is a glass base member, it is also called a cover glass. When the first base member 25 is formed of a light-transmitting resin, it may have flexibility. The same base member as the first base member 25 may be bonded to the first principal surface 10A of the array substrate 10 with an optical resin interposed therebetween.

As illustrated in FIGS. 5 and 6, the second base member 27 has a first principal surface 27A, a second principal surface 27B, a first side surface 27C, a second side surface 27D, a third side surface 27E, and a fourth side surface 27F. The first principal surface 27A and the second principal surface 27B are flat surfaces parallel to each other. The first side surface 27C and the second side surface 27D are flat surfaces parallel to each other. The third side surface 27E and the fourth side surface 27F are flat surfaces parallel to each other.

The second base member 27 is bonded to the first principal surface 10A of the array substrate 10 with an optical resin 26 interposed therebetween. The second base member 27 is a protective substrate for the array substrate 10, and is formed, for example, of glass or a light-transmitting resin. When the second base member 27 is a glass base member, it is also called a cover glass. When the second base member 27 is formed of a light-transmitting resin, it may have flexibility.

As illustrated in FIGS. 5 and 6, the light source 3 faces the second side surface 25D of the first base member 25. The light source 3 may also be called a side light source. As illustrated in FIG. 5, the light source 3 emits light-source light to the second side surface 25D of the first base member 25. The second side surface 25D of the first base member 25 facing the light source 3 serves as a plane of light incidence. The plane of light incidence facing the light source 3 may be the second side surface 20D of the counter substrate 20 or the second side surface 27D of the second base member 27.

The light source 3 includes the light emitters 31 and a light guide 33L. The light emitter 31 includes the light emitter 33R of the first color (such as red), the light emitter 33G of the second color (such as green), and the light emitter 33B of the third color (such as blue). The light guide 33L guides the light emitted by the light emitter 33R of the first color, the light emitter 33G of the second color, and the light emitter 33B of the third color to the second side surface 25D of the first base member 25. The light guide 33L simultaneously receives the light from the light emitters 31, internally diffuses the received light, and emits the diffused light to the display panel 2. As a result, the light emitted to the second side surface 25D of the first base member 25 is distributed uniformly per unit area.

The light guide 33L is the single light guide 33L formed integrally from the third side surface 25E to the fourth side surface 25F. The light guide 33L may be formed by arranging a plurality of divided light guides from the third side surface 25E to the fourth side surface 25F. The light guide 33L may be formed by arranging a plurality of divided light guides from the third side surface 25E to the fourth side surface 25F and connecting the adjacent light guides to each other.

The light emitters 31 and the light guide 33L are fixed together with an adhesive material or the like, and assembled to a support 33M to form a light source module. The support 33M is mounted so as to overlap the first principal surface 25A of the first base member 25, and is fixed to the first base member 25 with an adhesive material or the like.

The wiring board 93 (flexible printed circuit board or PCB) is provided with an integrated circuit of the light source controller 32, and the light source controller 32 is coupled to the light source 3 via the wiring board 93 (flexible printed circuit board or PCB). The wiring board 93 is fixed to the support 33M with an adhesive material or the like.

As illustrated in FIG. 5, the light-source light emitted from the light source 3 propagates in a direction (second direction PY) away from the second side surface 20D while being reflected by any of the first base member 25, the array substrate 10, the counter substrate 20, and the second base member 27.

As illustrated in FIG. 5, the light-source light that has propagated in any of the first base member 25, the array substrate 10, the counter substrate 20, and the second base member 27 is scattered by the pixels Pix including the liquid crystal placed in the scattering state, and the angle of incidence of the scattered light becomes an angle smaller than the critical angle. Thus, emission light 68 or 68A is emitted outward from the first principal surface 20A of the counter substrate 20 (the first principal surface 25A of the first base member 25) or the first principal surface 10A of the array substrate 10, respectively. The emission light 68 or 68A emitted outward from the first principal surface 20A of the counter substrate 20 or the first principal surface 10A of the array substrate 10, respectively, is viewed by a viewer.

Therefore, as illustrated in FIG. 6, the light emitters 31 are arranged at a predetermined pitch in an area corresponding to the active area AA along the second direction PY.

As illustrated in FIG. 6, the drive circuit 4 described above includes a plurality of integrated circuits of the gate drive circuit 43 and a plurality of integrated circuits of the source drive circuit 44.

The following describes the polymer-dispersed liquid crystal in the scattering state and the polymer-dispersed liquid crystal in the non-scattering state, using FIGS. 7 to 9.

As illustrated in FIG. 7, the array substrate 10 is provided with a first alignment film AL1. The counter substrate 20 is provided with a second alignment film AL2. When the alignment films are subjected to orientation treatments, for example, the first alignment film AL1 is oriented toward one side in the first direction PX, and the second alignment film AL2 is oriented toward the other side in the first direction PX. The first and the second alignment films AL1 and AL2 may be, for example, vertical alignment films, or may be alignment films oriented in the first direction PX in which the light emitters 31 are arranged. The orientation treatments are performed by performing rubbing treatments or photo-orientation treatments.

The polymer-dispersed liquid crystal LC of the liquid crystal layer 50 illustrated in FIG. 7 is enclosed between the array substrate 10 and the counter substrate 20. Then, in a state where the monomer and the liquid crystal are oriented by the first and the second alignment films AL1 and AL2, the monomer is polymerized by ultraviolet rays or heat to form a three-dimensional mesh-like polymer network 51. This process forms the liquid crystal layer 50 including the reverse-mode polymer-dispersed liquid crystal LC in which liquid crystal molecules 52 are dispersed in gaps of the three-dimensional mesh-like polymer network 51 formed in the mesh shape.

Thus, the polymer-dispersed liquid crystal LC includes the three-dimensional mesh-like polymer network 51 and the liquid crystal molecules 52.

The orientation of the liquid crystal molecules 52 is controlled by a voltage difference between the pixel electrode PE and the common electrode CE. The voltage applied to the pixel electrode PE changes the orientation of the liquid crystal molecules 52. The degree of scattering of light passing through the pixels Pix changes with change in the orientation of the liquid crystal molecules 52.

For example, as illustrated in FIG. 8, the direction of an optical axis Ax1 of the polymer network 51 is substantially equal to the direction of an optical axis Ax2 of the liquid crystal molecules 52 when no voltage is applied between the pixel electrode PE and the common electrode CE. The optical axis Ax2 of the liquid crystal molecules 52 is parallel to the first direction PX (FIG. 1) of the liquid crystal layer 50. The optical axis Ax1 of the polymer network 51 is parallel to the first direction PX of the liquid crystal layer 50 regardless of whether a voltage is applied.

Ordinary-ray refractive indices of the polymer network 51 and the liquid crystal molecules 52 are equal to each other. When no voltage is applied between the pixel electrode PE and the common electrode CE, the difference in refractive index between the polymer network 51 and the liquid crystal molecules 52 is substantially zero in all directions. The liquid crystal layer 50 is placed in the non-scattering state of not scattering the light-source light. The light-source light propagates in a direction away from the light source 3 (light emitters 31). When the liquid crystal layer 50 is in the non-scattering state of not scattering the light-source light, a background on the first principal surface 20A side of the counter substrate 20 is visible from the first principal surface 10A of the array substrate 10, and a background on the first principal surface 10A side of the array substrate 10 is visible from the first principal surface 20A of the counter substrate 20.

As illustrated in FIG. 9, in the gap between the pixel electrode PE and the common electrode CE having a voltage applied thereto, the optical axis Ax2 of the liquid crystal molecules 52 is inclined by an electric field generated between the pixel electrode PE and the common electrode CE. Since the optical axis Ax1 of the polymer network 51 is not changed by the electric field, the direction of the optical axis Ax1 of the polymer network 51 differs from the direction of the optical axis Ax2 of the liquid crystal molecules 52. The light-source light is scattered in the pixel Pix including the pixel electrode PE having a voltage applied thereto. As described above, the viewer views a part of the scattered light-source light emitted outward from the first principal surface 10A of the array substrate 10 or the first principal surface 20A of the counter substrate 20.

In the pixel Pix including the pixel electrode PE having no voltage applied thereto, the background on the first principal surface 20A side of the counter substrate 20 is visible from the first principal surface 10A of the array substrate 10, and the background on the first principal surface 10A side of the array substrate 10 is visible from the first principal surface 20A of the counter substrate 20. In the display device 1 of the present embodiment, when the first input signal VS is received from the image transmitter 91, the voltage is applied to the pixel electrode PE of the pixel Pix for displaying an image, and the image based on the third input signal VCSA becomes visible together with the background. Thus, an image is displayed in the display area when the polymer-dispersed liquid crystal LC is in the scattering state.

The light-source light is scattered in the pixel Pix including the pixel electrode PE having a voltage applied thereto, and emitted outward to display the image, which is displayed so as to be superimposed on the background. In other words, the display device 1 of the present embodiment can display the image so as to be superimposed on the background by combining the emission light 68 or 68A with the background.

A potential of each of the pixel electrodes PE (refer to FIG. 7) written during the one vertical scan period GateScan illustrated in FIG. 3 needs to be held during at least one of the first color light emission period RON, the second color light emission period GON, and the third color light emission period BON after each one vertical scan period GateScan. If the written potential of each of the pixel electrodes PE (refer to FIG. 7) cannot be held during at least one of the first color light emission period RON, the second color light emission period GON, and the third color light emission period BON after each one vertical scan period GateScan, what are called flickers, for example, are likely to occur. In other words, in order to shorten the one vertical scan period GateScan serving as a time for selecting the scan lines and increase the visibility in the driving based on what is called the field-sequential system, the written potential of each of the pixel electrodes PE (refer to FIG. 7) is required to be easily held during each of the first color light emission period RON, the second color light emission period GON, and the third color light emission period BON.

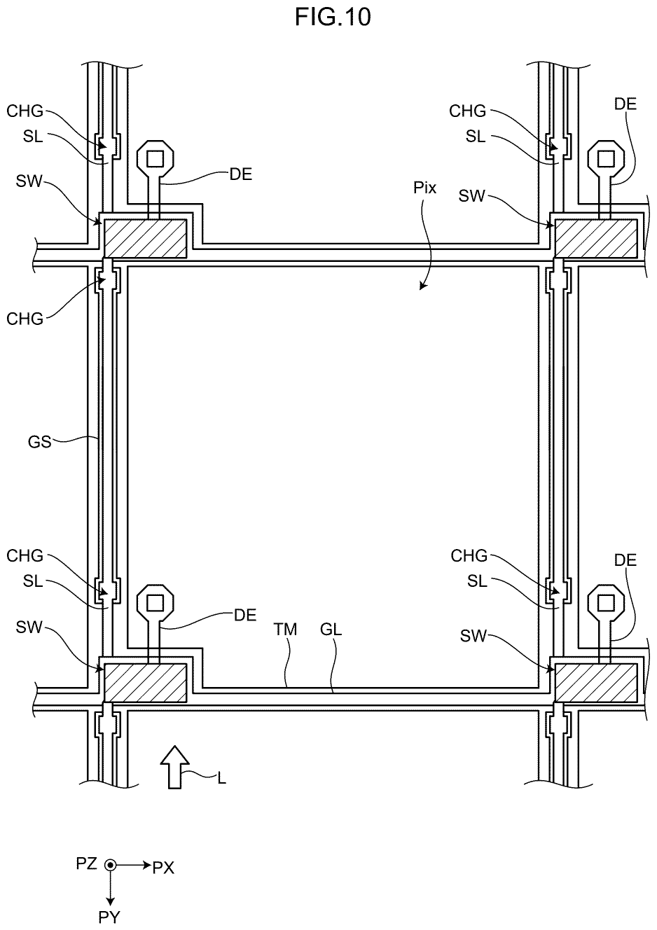

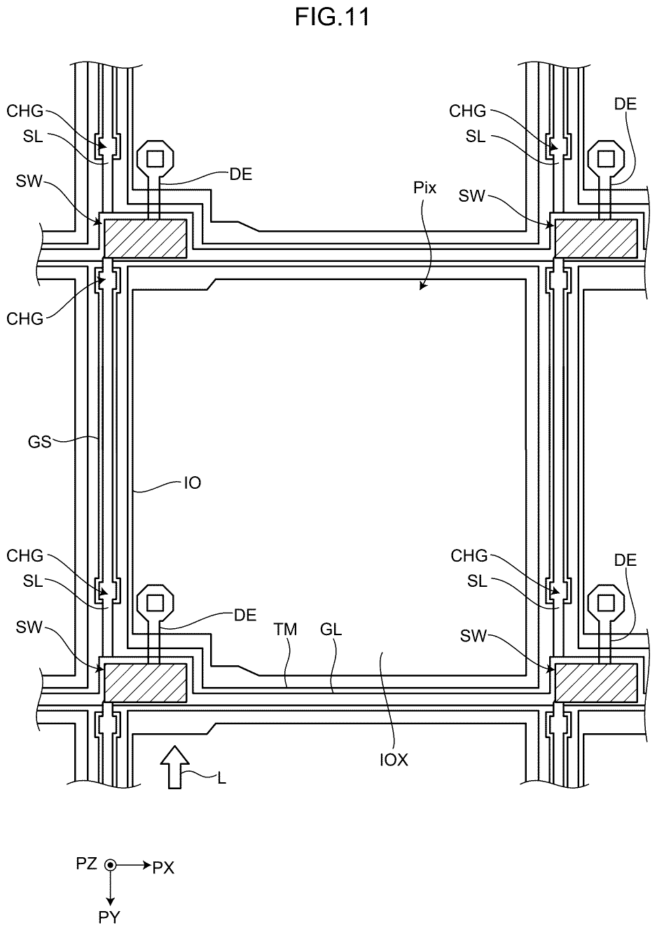

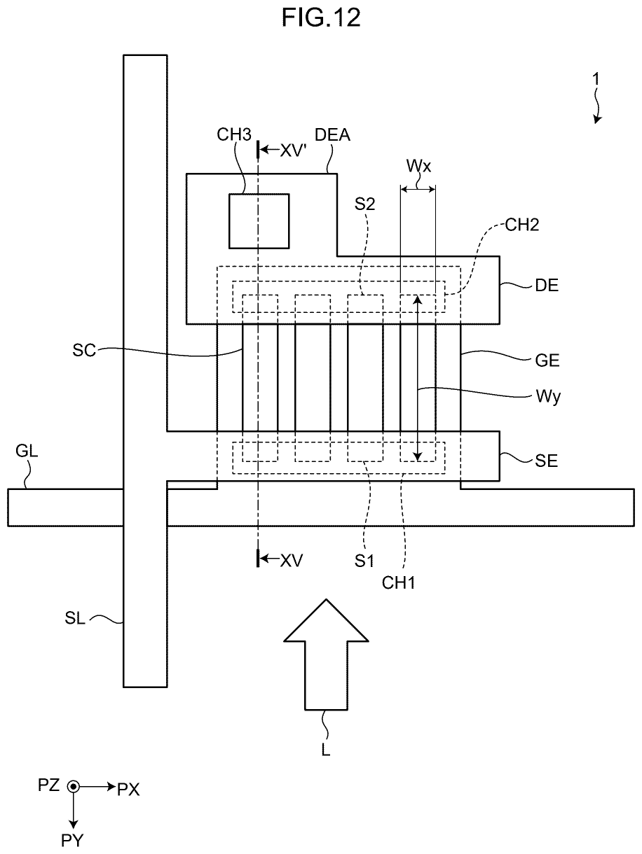

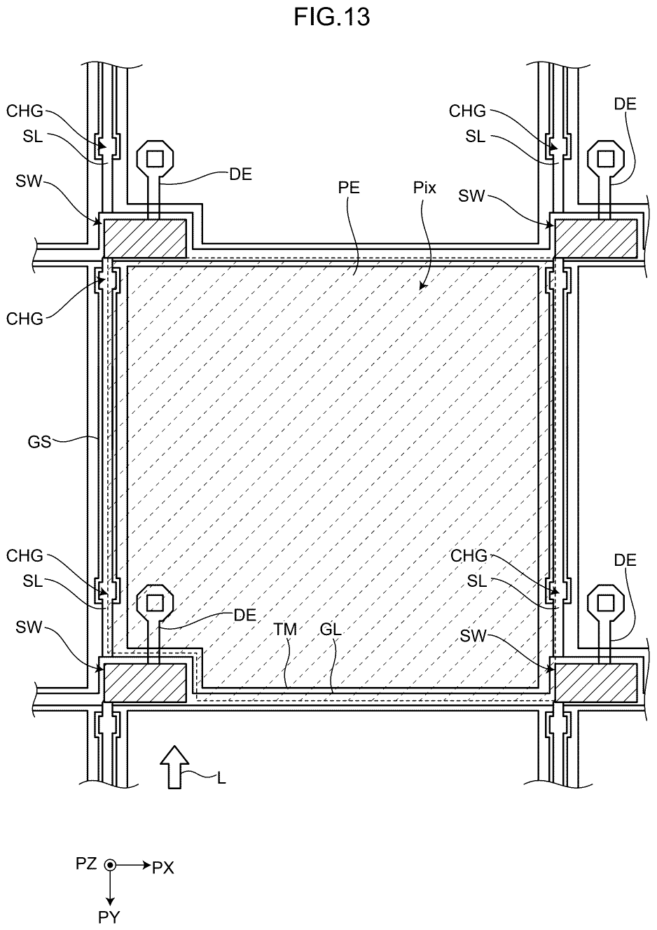

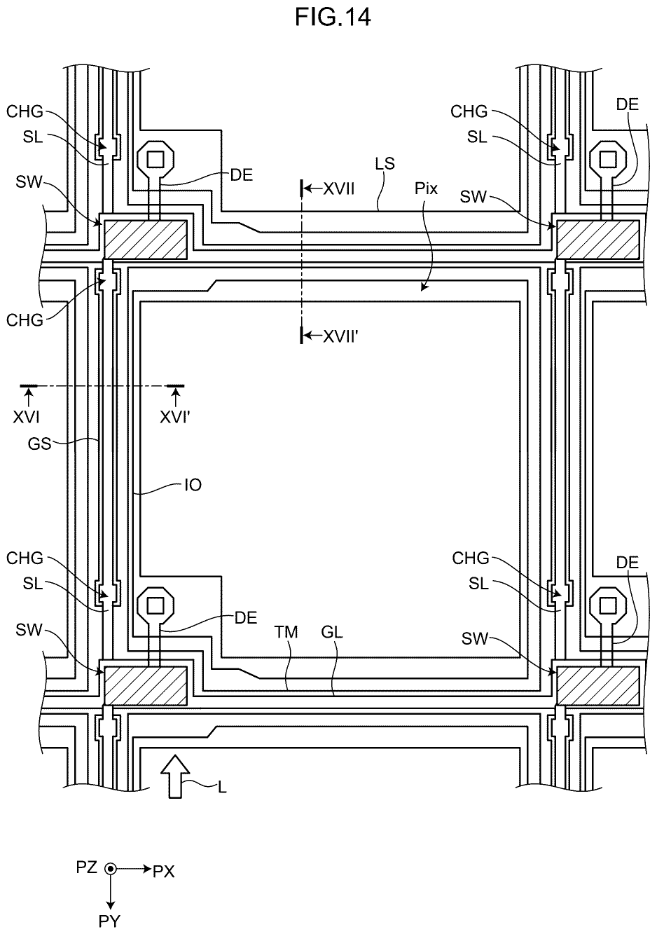

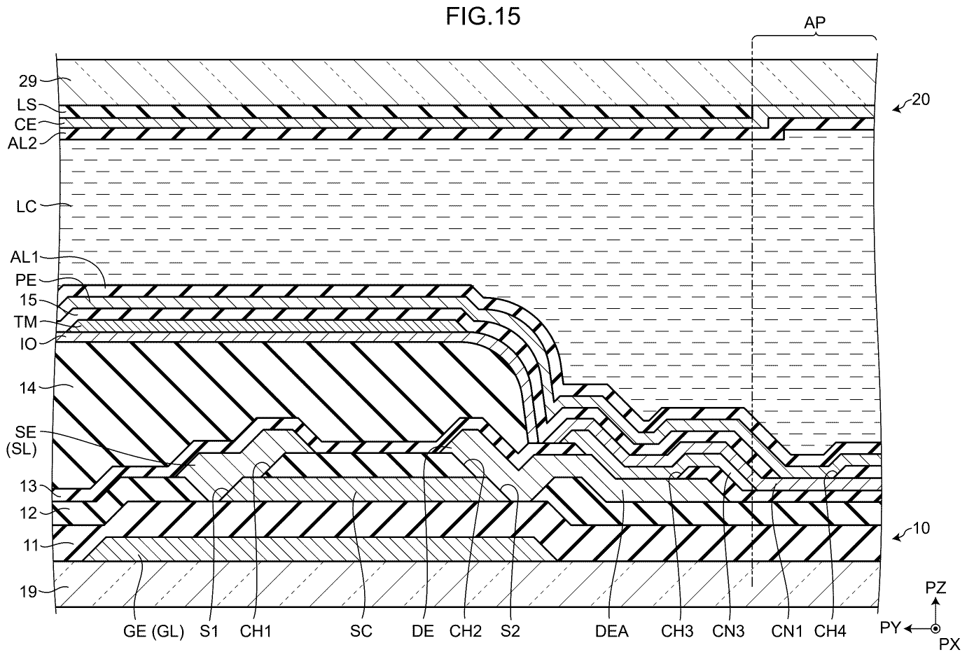

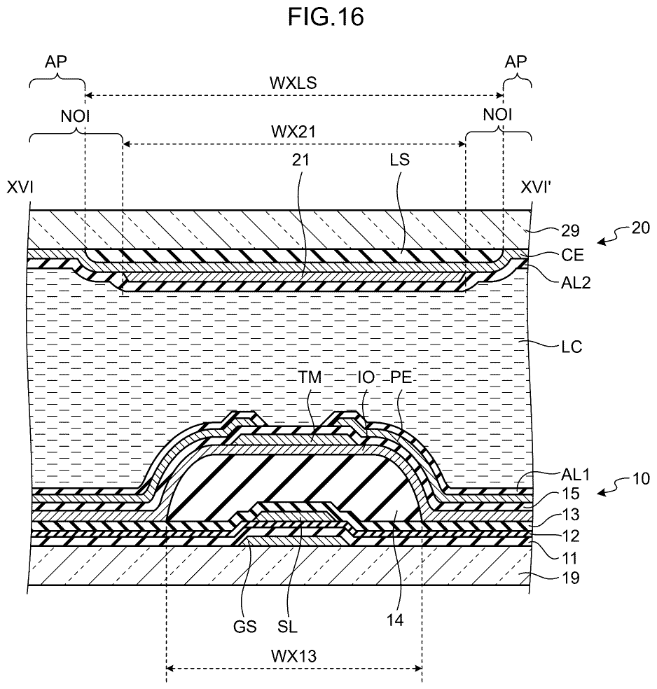

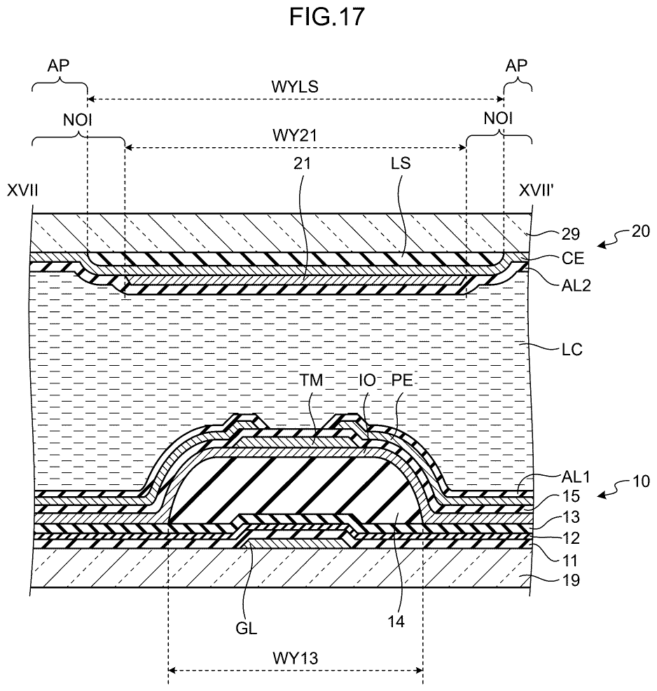

FIG. 10 is a plan view illustrating the scan lines, the signal lines, and the switching element in the pixel. FIG. 11 is a plan view illustrating a holding capacitance layer in the pixel. FIG. 12 is a plan view illustrating the switching element in the pixel. FIG. 13 is a plan view illustrating the pixel electrode in the pixel. FIG. 14 is a plan view illustrating a light-blocking layer in the pixel. FIG. 15 is a sectional view taken along section XV-XV′ in FIG. 12. FIG. 16 is a sectional view taken along section XVI-XVI′ in FIG. 14. FIG. 17 is a sectional view taken along section XVII-XVII′ in FIG. 14.

As illustrated in FIGS. 1, 2, and 10, the array substrate 10 is provided with the signal lines SL and the scan lines GL so as to in a grid pattern in plan view. In other words, one surface of the array substrate 10 is provided with the signal lines SL arranged at intervals in the first direction PX and the scan lines GL arranged at intervals in the second direction PY.

As illustrated in FIG. 10, an area surrounded by the adjacent scan lines GL and the adjacent signal lines SL corresponds to the pixel Pix. The pixel Pix is provided with the pixel electrode PE and a switching element placement area SW for the switching element Tr (refer to FIG. 2).

As illustrated in FIG. 10, the scan lines GL are wiring of a metal such as molybdenum (Mo) or aluminum (Al), a multilayered body of these metals, or an alloy thereof. The signal lines SL are wiring of a metal such as aluminum or an alloy thereof.

As illustrated in FIG. 12, the switching element Tr includes semiconductor layers SC, a gate electrode GE integrated with the scan line GL, a source electrode SE integrated with the signal line SL, and a drain electrode DE. In the present embodiment, the switching element Tr is a bottom-gate thin-film transistor. The source electrode SE and the drain electrode DE each extend along the first direction PX and are arranged at an interval along the second direction PY. The source electrode SE is in contact with one end side of each of the semiconductor layers SC included in the switching element Tr. The drain electrode DE is in contact with the other end side of each of the semiconductor layers SC. A contact electrode DEA is coupled to a side of the drain electrode DE opposite to the semiconductor layers SC in the second direction PY.

The semiconductor layer SC is, for example, an oxide semiconductor. The semiconductor layer SC may be polycrystalline silicon or amorphous silicon. The multiple semiconductor layers SC are arranged at intervals in the first direction PX. For example, four semiconductor layers SC are disposed on the gate electrode GE and arranged at intervals in the first direction PX. Each of the semiconductor layers SC is rectangular in shape with a longitudinal direction along the second direction PY. The semiconductor layers SC are provided so as not to protrude from the gate electrode GE in plan view.

As illustrated in FIG. 12, light-source light L emitted from the light source 3 (refer to FIG. 5) is incident in the second direction PY serving as a direction of incidence. The direction of incidence refers to a direction from the second side surface 20D closest to the light source 3 (refer to FIG. 5) toward the first side surface 20C that is the opposite surface to the second side surface 20D. Each of the semiconductor layers SC included in the switching element Tr has a first width Wx in the first direction PX intersecting the direction of incidence of the light from the light source 3 and a second width Wy in the second direction PY parallel to the direction of incidence, the first width Wx being smaller than the second width Wy. This configuration reduces effects of light leakage of the switching element Tr in the display device 1 of the present embodiment.

The contact electrode DEA at one end of the drain electrode DE is coupled to the pixel electrode PE via coupling electrodes CN1 and CN3 (refer to FIG. 15).

As illustrated in FIG. 15, the array substrate 10 includes a first light-transmitting base member 19 formed of glass, for example. The material of the first light-transmitting base member 19 may be any material having a light transmitting property and may be, for example, a resin such as polyethylene terephthalate.

As illustrated in FIG. 15, the scan line GL (refer to FIG. 10) and the gate electrode GE are provided on the first light-transmitting base member 19.

As illustrated in FIG. 15, a first insulating layer 11 (gate insulating layer) is provided so as to cover the scan line GL and the gate electrode GE. The first insulating layer 11 is formed of a transparent inorganic insulating material such as silicon nitride, for example.

The semiconductor layer SC is stacked on the first insulating layer 11. The semiconductor layer SC has a first side surface S1 and a second side surface S2. The first side surface S1 is located closer to a side from which light is incident, and the second side surface S2 is opposite the first side surface S1 and located farther from the side from which the light is incident. The first and the second side surfaces S1 and S2 correspond to the short sides of the semiconductor layer SC in plan view.

A second insulating layer 12 covering the semiconductor layer SC is provided on the first insulating layer 11. The second insulating layer 12 is formed, for example, of a transparent inorganic insulating material such as silicon nitride, in the same way as the first insulating layer 11. The second insulating layer 12 is provided so as to cover most of the semiconductor layer SC and the first insulating layer 11. A contact hole CH1 (opening) is provided in an area of the second insulating layer 12 that overlaps the first side surface S1 of the semiconductor layer SC. A contact hole CH2 (opening) is provided in an area of the second insulating layer 12 that overlaps the second side surface S2 of the semiconductor layer SC. As illustrated in FIG. 12, the contact hole CH1 extends in the first direction PX and is provided across the first side surfaces S1 of the semiconductor layers SC. In the same way, the contact hole CH2 extends in the first direction PX and is provided across the second side surfaces S2 of the semiconductor layers SC.

As illustrated in FIG. 15, the source electrode SE, the signal line SL, and the drain electrode DE are provided on the second insulating layer 12. The drain electrode DE is formed of the same material as the signal line SL. The source electrode SE is coupled to one end side of the semiconductor layer SC through the contact hole CH1. In more detail, the source electrode SE contacts the first insulating layer 11 so as to cover the side surface of the contact hole CH1 formed in the second insulating layer 12, and also cover a portion of the upper surface and the first side surface S1 of the semiconductor layer SC located in the contact hole CH1.

The drain electrode DE is coupled to the other end side of the semiconductor layer SC through the contact hole CH2. In more detail, the drain electrode DE contacts the first insulating layer 11 so as to cover the side surface of the contact hole CH2 formed in the second insulating layer 12, and also cover a portion of the upper surface and the second side surface S2 of the semiconductor layer SC located in the contact hole CH2.

As illustrated in FIG. 12, the source electrode SE extends in the first direction PX and is provided so as to cover the first side surfaces S1 of the semiconductor layers SC in an area overlapping the contact hole CH1. In the same way, the drain electrode DE extends in the first direction PX and is provided so as to cover the second side surfaces S2 of the semiconductor layers SC in an area overlapping the contact hole CH2.

With this configuration, the source electrode SE is provided so as to cover the first side surfaces S1 located on the incident direction sides of the semiconductor layers SC, thereby blocking the light-source light L incident on the first side surfaces S1 of the semiconductor layers SC. The drain electrode DE is provided so as to cover the second side surfaces S2 of the semiconductor layers SC, thereby blocking the light-source light L incident on the second side surfaces S2 of the semiconductor layers SC. This configuration reduces the effects of the light leakage of the switching element Tr in the display device 1 of the present embodiment.

The second insulating layer 12 is provided between the source electrode SE and the semiconductor layer SC and between the drain electrode DE and the semiconductor layer SC so as to cover the semiconductor layer SC. Therefore, in a process of patterning the source electrode SE (signal line SL) and the drain electrode DE through dry etching or the like, the semiconductor layer SC can be made less likely to be damaged because the semiconductor layer SC is covered by the second insulating layer 12 except in areas in which the contact holes CH1 and CH2 are formed.

As illustrated in FIG. 15, a third insulating layer 13 is provided on the signal line SL and the drain electrode DE. The third insulating layer 13 is formed, for example, of a transparent inorganic insulating material such as silicon nitride, in the same way as the first insulating layer 11.

The contact electrode DEA at one end of the drain electrode DE is located in an area that does not overlap an opening AP of the pixel Pix, and overlaps the coupling electrode CN3. A contact holes CH3 is formed in the third insulating layer 13 interposed between the drain electrode DE and the coupling electrode CN3. The drain electrode DE is in contact with the coupling electrode CN3 in the contact hole CH3.

The coupling electrode CN1 is in contact with the coupling electrode CN3. As a result, the coupling electrode CN1 is electrically coupled to the switching element Tr, and electrically coupled to the pixel electrode PE illustrated in FIG. 13 in a contact hole CH4 formed in a fifth insulating layer 15. The coupling electrode CN1 is a light-transmitting electrode formed of the same material as the holding capacitance electrode IO to be described later, and the drain electrode DE and the coupling electrode CN3 are formed of a metal material.

A fourth insulating layer 14 covering a portion of the third insulating layer 13 is formed on the third insulating layer 13. The fourth insulating layer 14 is an organic insulating layer formed, for example, of a light-transmitting organic insulating material such as an acrylic resin. The fourth insulating layer 14 has a film thickness greater than other insulating films formed of an inorganic material.

As illustrated in FIGS. 15, 16, and 17, an area with the fourth insulating layer 14 and an area without the fourth insulating layer 14 are present. As illustrated in FIGS. 16 and 17, the area with the fourth insulating layer 14 is above the scan lines GL and above the signal lines SL. The fourth insulating layer 14 has a grid shape that extends along the scanning lines GL and the signal lines SL and covers the scan lines GL and the signal lines SL. As illustrated in FIG. 15, the area with the fourth insulating layer 14 is located is above the semiconductor layer SC, that is, above the switching elements Tr. Therefore, the switching element Tr, the scan line GL, and the signal line SL are relatively far from the holding capacitance electrode IO, thereby being less affected by the common potential from the holding capacitance electrode IO. Furthermore, the array substrate 10 has the area without the fourth insulating layer 14 in an area surrounded by the scan lines GL and the signal lines SL, and thus has an area where the insulating layers have a thickness less than the insulating layers overlapping the scan lines GL and the signal lines SL in plan view. In the area surrounded by the scan lines GL and the signal lines SL, the transmittance of light increases relative to that above the scan line GL and above the signal line SL, resulting in improved light-transmitting property.

As illustrated in FIG. 15, the holding capacitance electrode IO is provided on the fourth insulating layer 14. The holding capacitance electrode IO is formed of a light-transmitting conductive material such as indium tin oxide (ITO). The holding capacitance electrode IO is also called “third light-transmitting electrode”. As illustrated in FIG. 11, the holding capacitance electrode IO has an area IOX including no light-transmitting conductive material in the area surrounded by the scan lines GL and the signal lines SL. The holding capacitance electrode IO is provided over the pixels Pix so as to span the adjacent pixels Pix. An area of the holding capacitance electrode IO including the light-transmitting conductive material overlaps the scan line GL or the signal line SL, and extends to the adjacent pixel Pix.

The coupling electrode CN1 is separated from the holding capacitance electrode IO and is located on the third insulating layer 13 at an opening of the fourth insulating layer 14 or at the opening (area IOX (refer to FIG. 11)) of the holding capacitance electrode IO. The holding capacitance electrode IO and the coupling electrode CN1 are located in substantially the same layer and are formed of the same material. The coupling electrode CN1 is located on the coupling electrode CN3 and is in contact with the coupling electrode CN3.

As illustrated in FIG. 15, a metal layer TM is provided on the fourth insulating layer 14 and the holding capacitance electrode IO. The conductive metal layer TM is wiring of a metal such as molybdenum (Mo) or aluminum (Al), a multilayered body of these metals, or an alloy thereof. Since the metal layer TM has lower resistance than the holding capacitance electrode IO, the variation in the holding capacitance among the pixel Pix is reduced. The metal layer TM is provided in an area overlapping the signal lines SL, the scan lines GL, and the switching elements Tr in plan view. With this configuration, the metal layer TM is formed into a grid shape, and openings surrounded by the metal layer TM are formed. Thus, the metal layer TM serves as power supply lines that supply the potential of the holding capacitance.

The holding capacitance electrode IO has a grid shape that extends along the scanning lines GL and the signal lines SL and covers the scan lines GL and the signal lines SL. Since this configuration reduces the holding capacitance HC between the area IOX including no light-transmitting conductive material and the pixel electrode PE, the holding capacitance HC is adjusted by the size of the area IOX including no light-transmitting conductive material.

As illustrated in FIGS. 12 and 15, the switching element Tr coupled to the scan line GL and the signal line SL is provided. At least the switching element Tr is covered with the fourth insulating layer 14 that is an organic insulating layer, and the metal layer TM having a larger area than that of the switching element Tr is located above the fourth insulating layer 14. This configuration can reduce light leakage of the switching element Tr.

More specifically, the array substrate 10 includes the fourth insulating layer 14 that is the organic insulating layer that covers at least the switching element Tr, and the metal layer TM that is provided above the fourth insulating layer 14 so as to overlap the fourth insulating layer 14, and has a larger area than the switching element Tr. The area surrounded by the scan lines GL and the signal lines SL include an area having a thickness smaller than that of the fourth insulating layer 14 that overlaps the scan lines GL and the signal lines SL in plan view. This configuration forms a slant surface along which the thickness of the fourth insulating layer 14 changes, located on a side of the fourth insulating layer 14 closer, in the plan view, to the light source 3 than the switching element Tr is.

As illustrated in FIGS. 13, 15, 16 and 17, a portion of the pixel electrode PE overlaps the slant surface where the thickness of the fourth insulating layer 14 changes. This configuration stabilizes the behavior of the liquid crystal molecules between the adjacent pixels Pix.

As illustrated in FIG. 16, in plan view, the width of the metal layer TM overlapping the signal line SL is larger than the width of the signal line SL. This configuration restrains reflected light reflected by edges of the signal line SL from being emitted from the display panel 2. The width of the metal layer TM and the width of the signal line SL are lengths in a direction intersecting the extending direction of the signal line SL.

As illustrated in FIG. 17, the width of the metal layer TM overlapping the scan line GL is larger than the width of the scan line GL. The width of the metal layer TM and the width of the scan line GL are the lengths in a direction intersecting the extending direction of the scan line GL.

As illustrated in FIG. 15, the fifth insulating layer 15 is provided on the upper side of the holding capacitance electrode IO and the metal layer TM. The fifth insulating layer 15 is an inorganic insulating layer formed, for example, of a transparent inorganic insulating material such as silicon nitride.

As illustrated in FIG. 15, the pixel electrode PE is provided on the fifth insulating layer 15. The pixel electrode PE is formed of a light-transmitting conductive material such as ITO. The pixel electrode PE is electrically coupled to the contact electrode DEA through the contact hole CH4 provided in the fifth insulating layer 15 and the contact hole CH3 provided in the third insulating layer 13. As illustrated in FIG. 13, the pixel electrode PE is partitioned for each of the pixels Pix. The first alignment film AL1 is provided on the pixel electrode PE.

As illustrated in FIG. 16, in the display device 1 of the first embodiment, a light-blocking layer GS located in the same layer as that of the scan line GL is provided in a position extending along the signal line SL and overlapping a portion of the signal line SL. The light-blocking layer GS is formed of the same material as that of the scan line GL. The light-blocking layer GS is not provided at a portion where the scan line GL intersects the signal line SL in plan view.

As illustrated in FIG. 10, the light-blocking layer GS is electrically coupled to the signal line SL through a contact hole CHG. This configuration reduces resistance of wiring formed by the light-blocking layer GS and the signal line SL as compared to the resistance of wiring formed of only the signal line SL. As a result, the delay of the gradation signal supplied to the signal line SL is reduced. The contact hole CHG need not be provided, and the light-blocking layer GS need not be coupled to the signal line SL.

As illustrated in FIG. 16, the light-blocking layer GS is provided on the opposite side to the metal layer TM with the signal line SL therebetween. The width of the light-blocking layer GS is larger than the width of the signal line SL and smaller than the width of the metal layer TM. The width of the light-blocking layer GS, the width of the metal layer TM, and the width of the signal line SL are lengths in a direction intersecting the extending direction of the signal line SL. Thus, the light-blocking layer GS has a larger width than that of the signal line SL, and thereby reduces the emission of the light reflected by the edges of the signal line SL from the display panel 2. As a result, the visibility of images is improved in the display device 1.

As illustrated in FIG. 15, the counter substrate 20 includes a second light-transmitting base member 29 formed of glass, for example. The material of the second light-transmitting base member 29 may be any material having a light transmitting property and may be, for example, a resin such as polyethylene terephthalate.

As illustrated in FIGS. 14 and 15, the counter substrate 20 is provided with the light-blocking layer LS. The light-blocking layer LS is provided in an area overlapping the signal lines SL, the scan lines GL, and the switching elements Tr in plan view. The light-blocking layer LS is formed of a resin or a metal material colored in black.

As illustrated in FIGS. 14, 15, 16, and 17, the light-blocking layer LS has a larger width than that of the metal layer TM. This configuration suppresses the emission of reflected light reflected by edges of the signal line SL, the scan line GL, and the metal layer TM, from the display panel 2. As a result, the visibility of images is improved in the display device 1.

The common electrode CE is provided on the second principal surface 20B of the second light-transmitting base member 29 so as to cover the light-blocking layer LS. The common electrode CE is formed of a light-transmitting conductive material such as ITO. The second alignment film AL2 is provided on a surface of the common electrode CE facing the pixel electrode PE.

As illustrated in FIGS. 16 and 17, the counter substrate 20 of the display device 1 of the first embodiment includes a protective film 21. FIG. 15 does not illustrate the protective film 21. The protective film 21 is formed of an inorganic insulating material such as silicon nitride or silicon oxide having insulating and light-transmitting properties that covers the array substrate 10 side of the common electrode CE. The second alignment film AL2 is provided on the array substrate 10 side of the protective film 21.

The protective film 21 is formed at a location overlapping the fourth insulating layer 14. In an area overlapping the opening AP, the common electrode CE and the second alignment film AL are directly stacked without interposing the protective film 21. As a result, the planar shape of the protective film 21 has a grid shape, forming non-overlapping areas NOI of the protective film 21. The protective film 21 is not formed in the openings AP. However, the protective film 21 is not essential.

As described above, the display device 1 of the present embodiment includes the array substrate 10, the counter substrate 20, the liquid crystal layer 50 between the array substrate 10 and the counter substrate 20, and the light source 3 disposed so that light enters a side surface of the array substrate 10 or a side surface of the counter substrate 20. The array substrate 10 includes the signal lines SL arranged at intervals in the first direction PX, the scan lines GL arranged at intervals in the second direction PY, and the switching elements Tr coupled to the scan lines GL and the signal lines SL. The switching elements Tr each include the semiconductor layer SC that has the first side surface S1 located closer to a side from which the light from the light source 3 is incident and the second side surface S2 on the opposite side to the first side surface S1. The semiconductor layer SC has the first width Wx in the direction intersecting the incident direction and the second width Wy in the direction parallel to the incident direction, the first width Wx being smaller than the second width Wy. The source electrode SE coupled to the signal line SL covers the first side surface S1 of the semiconductor layer SC.

This configuration allows the display device 1 to reduce light entering the semiconductor layer SC included in the switching element Tr because the first width Wx in the direction intersecting the incident direction is smaller than the second width Wy. Since the source electrode SE is provided so as to cover the first side surface S1 of the semiconductor layer SC, the light-source light L incident on the first side surface S1 of the semiconductor layer SC is well blocked. Therefore, the display device 1 of the present embodiment can reduce the light leakage of the switching element Tr.

### First Modification

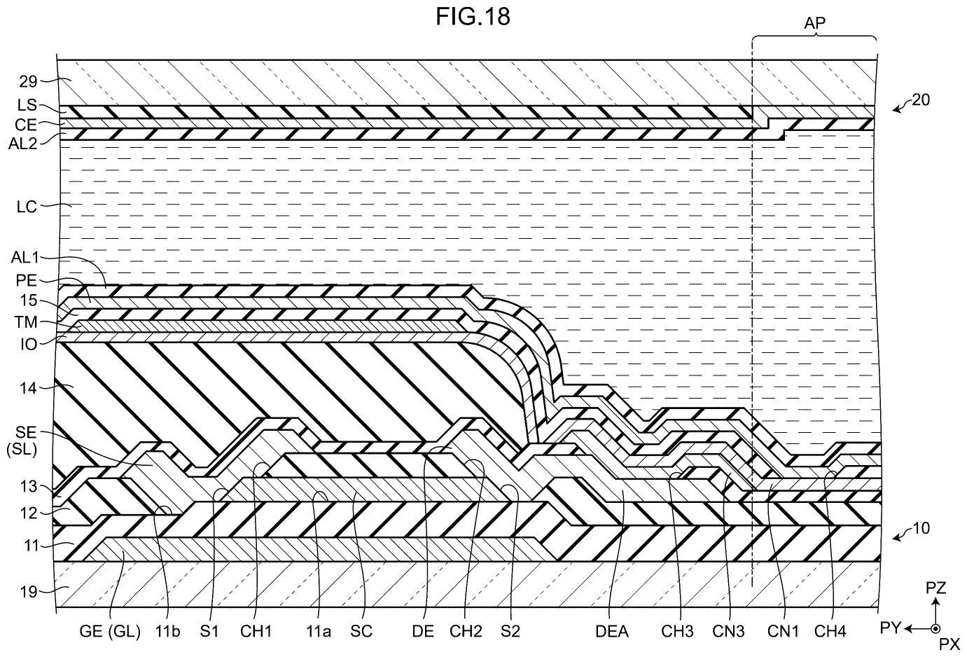

FIG. 18 is a sectional view illustrating the switching element according to a first modification of the present disclosure. As illustrated in FIG. 18, in the first modification, a step is formed at a portion of the first insulating layer 11 on a side (second direction PY side) closer to a side from which the light is incident than the first side surface S1 of the semiconductor layer SC is. That is, the upper surface of the first insulating layer 11 has a first upper surface 11a and a second upper surface 11b. The semiconductor layer SC is provided on the first upper surface 11a. The second upper surface 11b is provided closer to the first light-transmitting base member 19 than the first upper surface 11a is, in the third direction PZ.

In the area overlapping the contact hole CH1 formed in the second insulating layer 12, the source electrode SE covers a portion of the upper surface of the semiconductor layer SC and the first side surface S1 and also covers the step of the first insulating layer 11. In more detail, the source electrode SE contacts a portion of the first upper surface 11a and a portion of the second upper surface 11b of the first insulating layer 11 in the area overlapping the contact hole CH1. As a result, the source electrode SE is provided to a position in the third direction PZ closer to the first light-transmitting base member 19 than the lower surface of the semiconductor layer SC is, and covers the first side surface S1 of the semiconductor layer SC. As a result, in the first modification, the source electrode SE well blocks the light-source light L incident on the first side surface S1 of the semiconductor layer SC.

The step of the first insulating layer 11 can be formed by removing a portion of the first insulating layer 11 by etching or the like. The step of the first insulating layer 11 may alternatively be formed along a side surface of the gate electrode GE by arranging the gate electrode GE and the contact hole CH1 such that the side surface of the gate electrode GE is located in the area overlapping the contact hole CH1.

### Second Embodiment

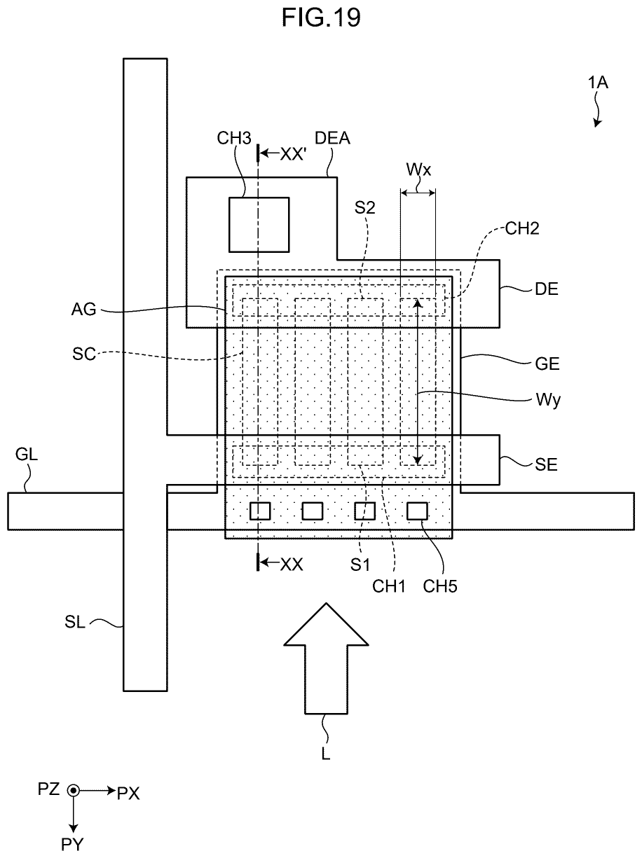

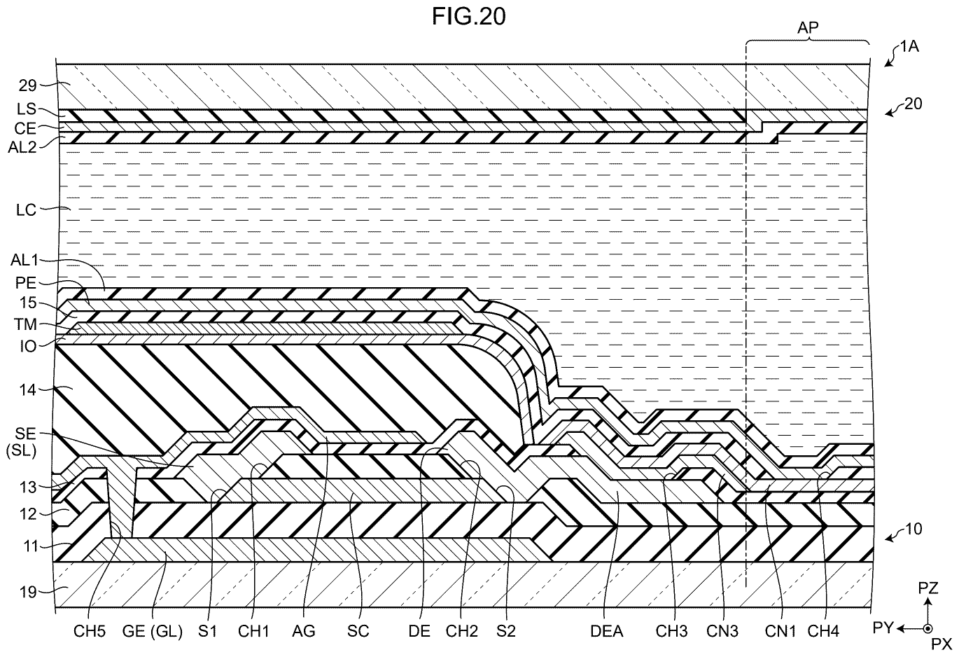

FIG. 19 is a plan view illustrating the switching element of a display device according to a second embodiment of the present disclosure. FIG. 20 is a sectional view taken along section XX-XX′ in FIG. 19.

As illustrated in FIGS. 19 and 20, in a display device 1A according to the second embodiment, the switching element Tr includes an auxiliary gate electrode AG. The auxiliary gate electrode AG overlaps the gate electrode GE and semiconductor layer SC. The semiconductor layer SC is located between the gate electrode GE and the auxiliary gate electrode AG in the third direction PZ. The auxiliary gate electrode AG further overlaps the scan line GL.

As illustrated in FIG. 20, the auxiliary gate electrode AG is provided on the third insulating layer 13. The auxiliary gate electrode AG faces the semiconductor layer SC in the third direction PZ with the second insulating layer 12 and the third insulating layer 13 interposed therebetween. The auxiliary gate electrode AG extends to the side closer to the side (second direction PY side) from which the light is incident than the first side surface S1 of the semiconductor layer SC is. The auxiliary gate electrode AG is electrically coupled to the gate electrode GE through a contact hole CH5 provided in the first, the second, and the third insulating layers 11, 12, and 13 on the first side surface S1 side of the semiconductor layer SC. With this configuration, the auxiliary gate electrode AG is electrically coupled to the scan line GL in the same way as the gate electrode GE. As a result, the gate electrode GE and the auxiliary gate electrode AG have the same potential as the scan line GL.

In the second embodiment, in addition to the source electrode SE, the auxiliary gate electrode AG is also provided so as to cover the first side surface S1 of the semiconductor layer SC. With this configuration, the source electrode SE and the auxiliary gate electrode AG block the light-source light L entering the first side surface S1 of the semiconductor layer SC.

The coupling configuration of the auxiliary gate electrode AG to the gate electrode GE is only schematically illustrated in FIGS. 19 and 20 and can be changed as appropriate. For example, the number of the contact holes CH5 is not limited to four, but may be three or less or five or more. The contact holes CH5 are not limited to the configuration that penetrates the first, the second, and the third insulating layers 11, 12, and 13, and coupling electrodes may be provided between the insulating layers as required.

### Second Modification

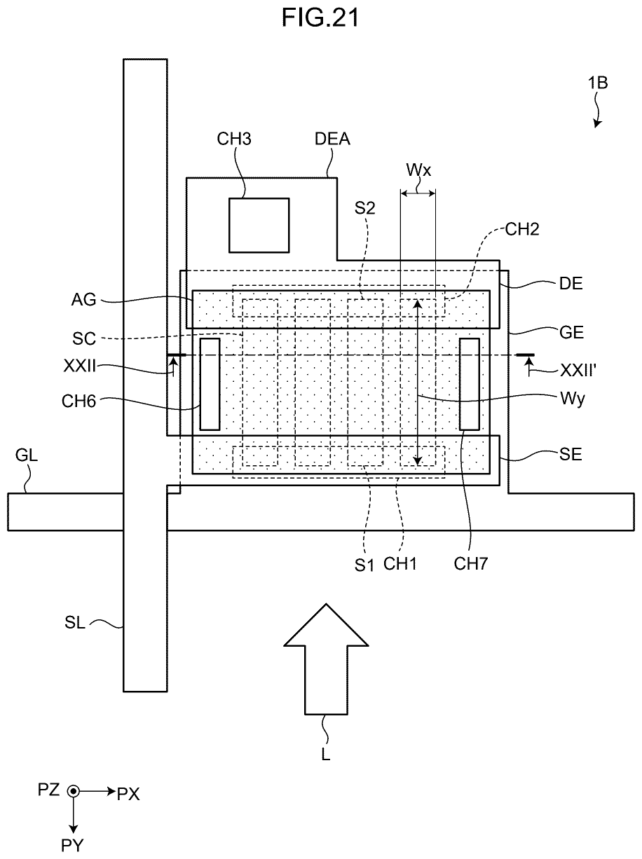

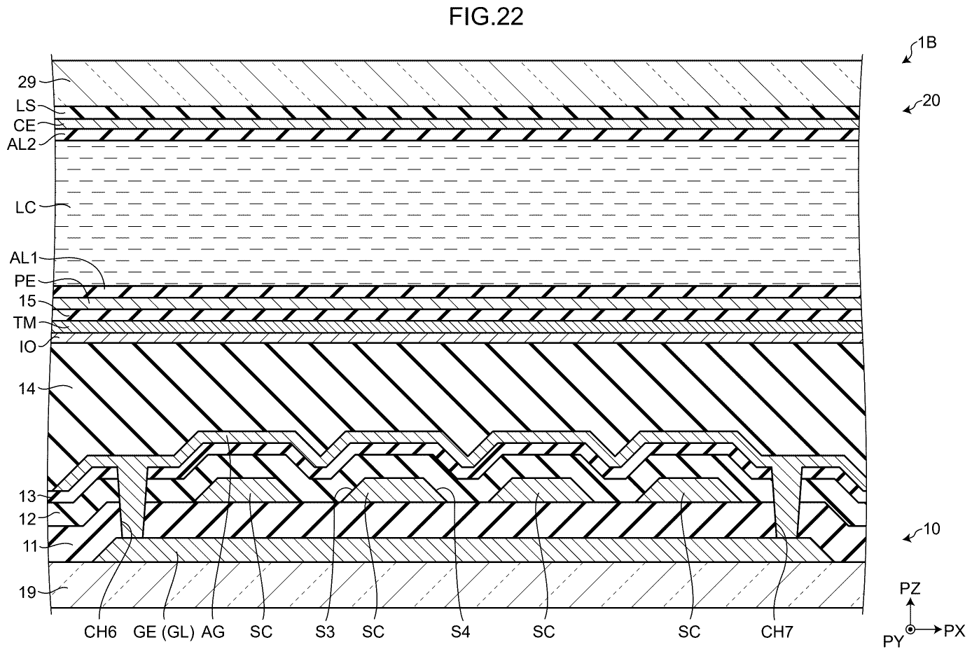

FIG. 21 is a plan view illustrating the switching element according to a second modification of the present disclosure. FIG. 22 is a sectional view taken along section XXII-XXII′ in FIG. 21. In the second embodiment described above, the auxiliary gate electrode AG is electrically coupled to the gate electrode GE on the first side surface S1 side of the semiconductor layer SC, that is, on the side closer to the side from which the light is incident. However, the coupling configuration between the auxiliary gate electrode AG and the gate electrode GE is not limited to this configuration.

As illustrated in FIGS. 21 and 22, in a display device 1B according to the second modification, the auxiliary gate electrode AG is electrically coupled to the gate electrode GE on at least one of the third side surface S3 side and the fourth side surface S4 side of the semiconductor layer SC in the direction intersecting the incident direction.

More specifically, each of the semiconductor layers SC arranged in the first direction PX has the third side surface S3 and the fourth side surface S4 provided between the first side surface S1 and the second side surface S2. As illustrated in FIG. 21, in the direction intersecting the incident direction (the first direction PX), a contact hole CH6 is provided between the signal line SL and the semiconductor layers SC arranged in the first direction PX. A contact hole CH7 is provided on the opposite side to the contact hole CH6 with respect to the semiconductor layers SC arranged in the first direction PX.

As illustrated in FIG. 22, the contact holes CH6 and CH7 each penetrate the first insulating layer 11, the second insulating layer 12, and the third insulating layer 13. This configuration electrically couples the auxiliary gate electrode AG to the gate electrode GE through the contact hole CH6 on the third side surface S3 sides of the semiconductor layers SC. The auxiliary gate electrode AG is electrically coupled to the gate electrode GE through the contact hole CH7 on the fourth side surface S4 sides of the semiconductor layers SC.

The auxiliary gate electrode AG is provided so as to cover the third side surfaces S3 and the fourth side surfaces S4 of the semiconductor layers SC. More specifically, the auxiliary gate electrode AG is provided so as to cover the semiconductor layers SC arranged in the first direction PX. The auxiliary gate electrode AG is provided so as to cover the fourth side surface S4 of one of the semiconductor layers SC located on one side in the first direction PX (right side in FIG. 22). The auxiliary gate electrode AG is provided so as to cover also the third side surface S3 of one of the semiconductor layers SC located on the other side in the first direction PX (left side in FIG. 22). With this configuration, the auxiliary gate electrode AG blocks the light-source light L incident on the third side surfaces S3 and the fourth side surfaces S4 of the semiconductor layers SC.

### Third Modification

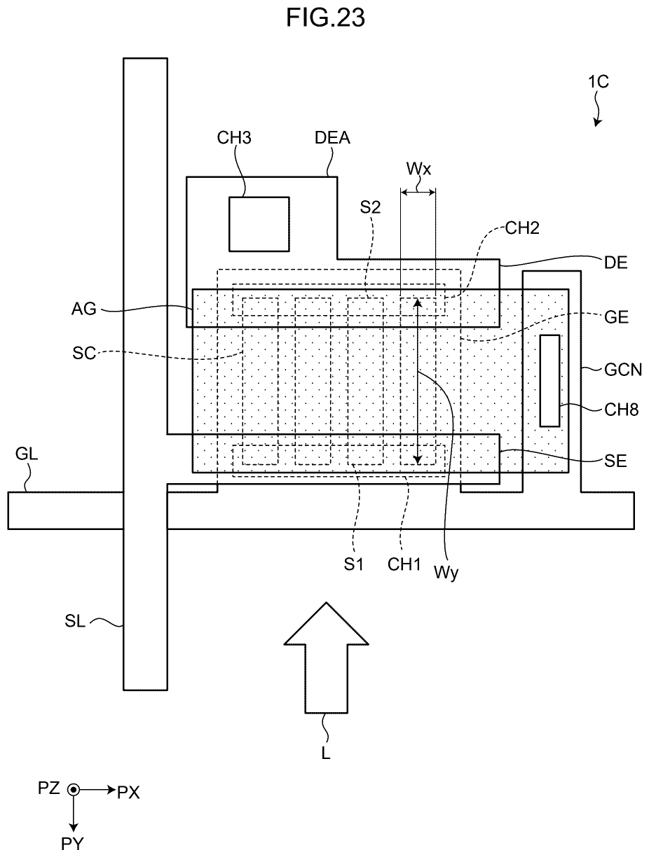

FIG. 23 is a plan view illustrating the switching element according to a third modification of the present disclosure. As illustrated in FIG. 23, a display device 1C according to the third modification includes a gate coupling electrode GCN. The gate coupling electrode GCN is provided in the same layer as the gate electrode GE on the first light-transmitting base member 19, and is positioned with a spacing from the gate electrode GE in the first direction PX. The gate coupling electrode GCN extends along the second direction PY and is coupled to the scan line GL on the same side as the gate electrode GE.

The auxiliary gate electrode AG extends in the first direction PX from an area overlapping the semiconductor layers SC to an area overlapping the gate coupling electrode GCN. The auxiliary gate electrode AG is electrically coupled to the gate coupling electrode GCN through a contact hole CH8 provided in the first insulating layer 11, the second insulating layer 12, and the third insulating layer 13 on the first direction PX side of the semiconductor layers SC. With this configuration, the auxiliary gate electrode AG is electrically coupled to the scan line GL in the same way as the gate electrode GE.

In the third modification, the auxiliary gate electrode AG is coupled to the gate coupling electrode GCN at a location overlapping neither the gate electrode GE nor the scan line GL. Therefore, in the third modification, the degree of freedom of coupling between the auxiliary gate electrode AG and the scan line GL can be improved.

While the preferred embodiments have been described above, the present disclosure is not limited to such embodiments. The content disclosed in the embodiments is merely an example, and can be variously modified within the scope not departing from the gist of the present disclosure. Any modifications appropriately made within the scope not departing from the gist of the present disclosure also naturally belong to the technical scope of the present disclosure. At least one of various omissions, substitutions, and modifications of the components can be made to the extent that it does not depart from the gist of each of the embodiments and the modifications described above.

What is claimed is:

1. A display device comprising:
an array substrate;
a counter substrate having a first end;
a liquid crystal layer between the array substrate and the counter substrate; and
a light source located on an opposite side to the liquid crystal layer on the first end, wherein
the array substrate comprises:
a plurality of signal lines arranged in a first direction;
a plurality of scan lines arranged in a second direction intersecting the first direction; and
a plurality of switching elements coupled to the scan lines and the signal lines,
each of the switching elements comprises a semiconductor layer that has a first side surface located on a side closer to the light source and a second side surface on an opposite side to the first side surface,
the semiconductor layer has a first width and a second width, the first width being a width in a direction intersecting an incident direction in which light is incident from the light source, the second width being a width in a direction parallel to the incident direction, the first width being smaller than the second width, and
a source electrode coupled to the signal line covers the first side surface of the semiconductor layer.

2. The display device according to claim 1, comprising a drain electrode that couples the semiconductor layer to a pixel electrode, wherein
the drain electrode covers the second side surface of the semiconductor layer.

3. The display device according to claim 1, comprising an insulating layer that covers the semiconductor layer and is provided with openings at respective locations overlapping the first side surface and the second side surface of the semiconductor layer, wherein
the source electrode covers a side surface of the insulating layer in which the openings are formed and the first side surface of the semiconductor layer.

4. The display device according to claim 1, comprising:
a gate electrode coupled to the scan line; and
a gate insulating layer provided between the gate electrode and the semiconductor layer, wherein
a step is formed at a portion of the gate insulating layer on the incident direction side of the first side surface of the semiconductor layer, and
the source electrode covers the first side surface of the semiconductor layer and also covers the step of the gate insulating layer.

5. The display device according to claim 1, comprising a gate electrode and an auxiliary gate electrode that are coupled to the scan line, wherein
the semiconductor layer is located between the gate electrode and the auxiliary gate electrode in a direction orthogonal to the array substrate,
the auxiliary gate electrode is electrically coupled to the gate electrode on the incident direction side of the first side surface of the semiconductor layer, and
the auxiliary gate electrode covers the first side surface of the semiconductor layer.

6. The display device according to claim 1, comprising a gate electrode and an auxiliary gate electrode that are coupled to the scan line, wherein
the semiconductor layer is located between the gate electrode and the auxiliary gate electrode in a direction orthogonal to the array substrate,
the semiconductor layer has a third side surface and a fourth side surface that are located between the first side surface and the second side surface,
the auxiliary gate electrode is electrically coupled to the gate electrode on at least one of the third side surface side and the fourth side surface side of the semiconductor layer, and
the auxiliary gate electrode covers at least one of the third side surface and the fourth side surface of the semiconductor layer.

7. The display device according to claim 1, wherein
the liquid crystal layer comprises a polymer-dispersed liquid crystal, and
a background of the counter substrate is visible from the array substrate, and a background of the array substrate is visible from the counter substrate.

8. A display device comprising:
a first substrate;
a second substrate facing the first substrate;
a liquid crystal layer between the first substrate and the second substrate;
a third substrate having a side surface, the second substrate being between the third substrate and the liquid crystal layer; and
a light source facing the side surface, wherein
the first substrate comprises pixels each provided with a switching element comprising a source electrode, a drain electrode, and a plurality of semiconductor layers,
the semiconductor layers are arranged in a predetermined direction,
each of the semiconductor layers has a first side surface located on a side closer to the light source and a second side surface on an opposite side to the first side surface, and
one of the source electrode and the drain electrode covers the first side surface.

9. The display device according to claim 8, wherein a direction of a channel width of each semiconductor layer is the predetermined direction.

10. The display device according to claim 8, further comprising an insulating film that covers the semiconductor layers, wherein
the insulating film is provided with a first opening that exposes the first side surfaces of all of the semiconductor layers, and
the one of the source electrode and the drain electrode is located in the first opening.

11. The display device according to claim 8, wherein the other of the source electrode and the drain electrode covers the second side surface.

12. The display device according to claim 11, further comprising an insulating film that covers the semiconductor layers, wherein
the insulating film is provided with a second opening that exposes the second side surfaces of all of the semiconductor layers, and
the other of the source electrode and the drain electrode is located in the second opening.

13. The display device according to claim 12, wherein
the insulating film is provided with a first opening that exposes the first side surfaces of all of the semiconductor layers, and
the one of the source electrode and the drain electrode is located in the first opening.

14. The display device according to claim 8, wherein the one of the source electrode and the drain electrode covers the first side surfaces of all of the semiconductor layers.

15. The display device according to claim 8, wherein the first side surface is between the light source and the second side surface.
